(19) United States
(12) Patent Application Publication
(10) Pub. No.: US 2012/0328807 A1
(43) Pub. Date: Dec. 27, 2012

(54) INSULATION DEVICE

(76) Inventor: Shaun Grimes, London (GB)

(21) Appl. No.: 13/608,294

(22) Filed: Sep. 10, 2012

Related U.S. Application Data
(63) Continuation of application No. PCT/GB2011/000323, filed on Mar. 7, 2011.

(30) Foreign Application Priority Data
Mar. 11, 2010 (GB) 1004042.6

(51) Int. Cl. B32B 1/02; B32B 3/14; B32B 3/02

(52) U.S. Cl. 428/35.5; 428/77; 428/78

(57) ABSTRACT

A flexible loft hatch insulation device as suitable to be used on all different types of loft hatches. Manufactured from a variety of different insulation materials including various waste streams. Application includes insulation as well as draught proofing.

### CROSS-REFERENCE TO RELATED APPLICATIONS

This application is a continuation of International Application No. PCT/GB2011/000323 filed 7 Mar. 2011, which claimed the benefit of Great Britain Application Serial No. 1004042.6, filed 11 Mar. 2010; the contents of all of which applications are incorporated herein by reference in their entireties.

### FIELD OF THE INVENTION

The present invention relates to an insulation device and in particular, but not exclusively, to an insulation device for a loft opening.

### BACKGROUND OF THE INVENTION

Many buildings are provided with a pitched roof to allow water to flow off the roof. The pitched roof often creates a relatively large space between a ceiling of the uppermost floor of the building and the roof itself; such a space is commonly referred to as an attic or loft, and is often used as a storage area.

Access to a loft is normally provided via an opening in the ceiling of the uppermost floor of a building and the opening is usually closable by means of a movable access door that is typically made of plywood or medium-density fibreboard (MDF).

Loft space in most buildings is provided with thermal insulation to prevent heat loss from the building through the roof. Insulating the loft reduces the amount of energy required to keep a building warm.

Whilst there are many products that can be used to insulate the main area of a loft space, loft openings are commonly left un-insulated allowing heat to escape from the interior of buildings through the loft openings. When heat escapes from the interior of a building in this manner, additional energy is required to compensate for the heat loss and maintain the interior of the building at a constant temperature.

### SUMMARY OF THE INVENTION

In accordance with one aspect of the present invention, there is provided an insulation device for a loft opening, the device comprising an insulating body portion adapted to fit within the loft opening and a skirt portion extending around at least a part of a periphery of the insulating body portion, wherein the skirt portion is adapted to be moveable relative to the insulating body portion.

The insulation device of the present invention can be fitted into a loft opening to insulate the opening and the skirt portion can additionally exclude draughts that may arise around the periphery of the opening. The insulation of the opening substantially reduces heat transfer through the opening, whilst the exclusion of draughts serves to reduce heat transfer around—the periphery of the opening. The fact that the skirt portion is movable relative to the insulating body portion of the insulation device means that movement of the insulation device within the loft opening is permitted. If, for example, the loft opening is equipped with a closure, such as an access door, and the insulation device is attached to the closure, the ability of the skirt portion of the insulation device to move relative to the insulating body portion allows the insulation device to move with the closure as it is opened and closed.

The insulating body of the insulation device may be made of an insulating material; alternatively, in a preferred embodiment of the present invention, the insulating body has a pillow-like structure that is filled with an insulating material. The pillow-like structure of the insulating body provides flexibility in the arrangement of the insulation device within a loft opening. Since the pillow-like structure is deformable, the insulation device can take up the shape of the loft opening in such a way that gaps are avoided between the insulation device and the periphery of the loft opening. In other words, where the shape of a loft opening is not perfectly regular, any irregularities can be compensated by the pillow-like structure of the insulation device. A further benefit of a pillow-like structure is that the insulation device is not particularly dense, which makes it easy to handle and transport. A pillow-like structure is also less likely to cause damage to areas of the loft or ceiling in the vicinity of the loft opening during installation due to a lack of rigidity.

The skirt portion may also be made of an insulating material or may have a pillow-like structure that is filled with an insulating material. This has the advantage of providing the skirt portion with thermal insulation properties in addition to draught exclusion properties.

Preferably, the skirt portion extends around the entire periphery of the insulating body portion. A skirt portion that extends around the entire periphery of the insulating body portion of the insulation device, rather than just around a part thereof, achieves more effective draught exclusion.

In a further preferred embodiment of the invention, the insulation device includes a fire retardant additive or a flame retardant additive, each of which enhances the fire safety characteristics of the insulation device by serving to prevent the spread of fire from a loft space into the interior of a building or from the interior of a building to the loft space.

The insulation device may be provided with a liner having thermal and/or fire retardant properties. Preferably, the liner has at least one perforation. The presence of at least one perforation in the liner reduces the weight of the liner; in some cases the inclusion of at least one perforation can also reduce the manufacturing cost of the liner. The liner may be a metal foil, for example. The liner preferably has a thickness in the range of 10 μm to 5 mm. This range provides a liner of sufficient thickness to achieve an acceptable level of thermal insulation and fire retardant capability whilst avoiding an excessive contribution to the overall weight of the insulation device.

The insulation material may be selected from any of cellulose, cellulose acetate, fibreglass, paper, cardboard, carpet, wool, polyester, mineral wool, shredded bank notes, foam, cotton, recycled clothing, polystyrene, or any combination thereof. A benefit of using all of these materials, either alone or in combination, is that they have good thermal insulation properties.

In a further preferred embodiment of the invention, the insulation device is provided with means for attaching the device to a closure for the loft opening. This enables the insulation device to be moved with a closure for the loft opening. It also ensures that the insulation device remains in a fixed position relative to the loft opening, which avoids the insulation device impeding the opening and closing of the closure, and achieves effective insulation of the opening and exclusion of draughts.

In a yet further preferred embodiment of the invention, the insulating body portion and the skirt portion are joined to one another by means of a stiffened seam. The stiffened seam provides an axis about which the skirt portion may move relative to the insulating body portion of the insulation device.

In accordance with a further aspect of the present invention, there is provided an insulation device for a loft opening. the device comprising an insulating body having a first portion adapted to fit within a loft opening and a second portion adapted to overlap a periphery of the loft opening, wherein the insulating body has a pillow-like structure.

In accordance with a yet further aspect of the present invention, there is provided a fire retardant bag for insulating a loft opening, wherein the bag is arranged to be filled with an insulating material so that it can assume a pillow-like structure, in use.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a side view of an insulation device in accordance with a first embodiment of the present invention arranged in a loft opening;

FIG. 2 shows a side view of an insulation device in accordance with a second embodiment of the present invention arranged in a loft opening;

FIG. 3 shows a plan view of the insulation device of FIG. 2;

FIG. 4 shows a side view of the insulation device of FIG. 2 arranged in a loft opening; and

FIG. 5 shows a side view of an insulation device in accordance with a third embodiment of the present invention.

### DETAILED DESCRIPTION OF THE INVENTION

Referring to FIG. 1, there is shown an insulation device 10 having an insulating body portion 11 and a skirt portion 12 that extends around a periphery of the insulating body portion 11.

The insulation device 10 is shown arranged in a loft opening 13 that is defined by a frame 14, and is attached to a loft opening closure 15 in the form of an access door by attachment means 16. The attachment means 16 can include glue, sticky-backed plastic, double-sided adhesive tape, hook and loop fasteners, adhesive paste, staples, nails, screws or any other suitable form of attachment. The attachment means 16 can be temporary or permanent and are arranged approximately 1 cm inside the periphery of the insulating body portion 11 but could be placed at any point on the insulating body portion 11 that provides a satisfactory attachment. By virtue of the attachment of the insulating device 10 to the access door 15, the insulating device can move with the access door 15 when it is opened and closed. In order to facilitate movement of the access door 15 in the loft opening 13 and allow insertion of the insulation device 10 into the loft, the insulation device 10 preferably has a slightly smaller top surface area than the area of the loft opening 13. For example, the length and width of the insulating body portion 11 could be between 0.5 mm and 40 mm less than the length and width of the loft opening 13.

It can be seen that the skirt portion 12 overlaps the periphery of the loft opening 13, so that it acts as a draught excluder and can block any gaps between the insulating body portion 11 and the periphery of the loft opening 13. The extension of the skirt portion 12 beyond the periphery of the loft opening 13 can be in the range of 1 cm to 40 cm. The skirt portion 12 may be made of an insulating material so that, in addition to draught exclusion, it also provides some degree of thermal insulation. The skirt portion 12 is movable relative to the insulating body portion 11, so that the skirt portion 12 does not impede movement of the access door 15. As the access door 15 is moved upwards, for example, the skirt portion 12 is folded inwards towards the centre of the loft opening 13 so that it does not block the path of the access door 15. The skirt portion 12 is joined to the insulating body portion 11 by means of a stiffened seam 17 that allows the skirt portion 12 to be moved easily relative to the insulating body portion 11.

The insulating body portion 11 has a pillow-like structure that is filled with an insulating material, such as cellulose, cellulose acetate, fibreglass, paper, cardboard, carpet (including recycled factory carpet waste and cleansed and recycled carpets), sheep or any other animal wool, polyester, mineral wool, shredded bank notes, foam, cotton, wool, recycled clothing or polystyrene (including expanded polystyrene), or any combination of these materials. The materials can be processed and sized according to specific insulation requirements. However, a density of filling in the range of 5 to 100 kg/m3 is generally required. In addition to a filling of insulating material, the insulating body portion 11 can contain fire and/or flame retardant additives or components. For example, the insulating body portion 11 can include a fire retardant liner (not shown) made of metal foil, or of any other suitable material. The thickness—of the liner can be determined according to the required level of fire safety required. For example, a thickness in the ran e of 10 μm to 5 mm would be suitable for most applications. The liner can also include at least one perforation.

An outer layer or casing 18 of the pillow-like structure may be made of any suitable material, including cotton, polyester or other synthetic fibres. The casing 18 could additionally or alternatively be made of a waterproof material or treated with a waterproofing agent. Similarly, the casing could be treated with a fire retardant additive and/or a flame retardant additive. The casing could additionally have a pattern or show branding or other corporate marketing material to improve the appearance of the insulation device 10.

The pillow-like structure of the insulating body portion 11 provides some flexibility in the arrangement of the insulation device 10 in the loft opening 13 because the deformability of the pillow-like structure allows the insulation device 10 to take up, at least to some extent, the shape of the loft opening 13, even if that loft opening 13 has an irregular configuration. The pillow-like structure also provides an insulating body portion 11 that is relatively lightweight and easy to handle.

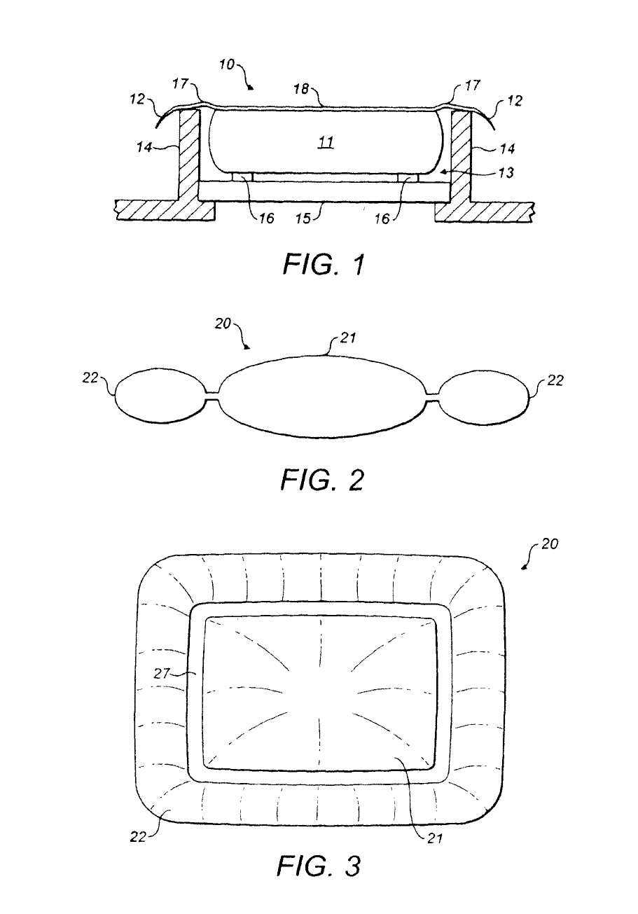

In FIG. 1, the pillow-like structure is in the form of a box with upright side walls. However, any configuration of pillow-like structure can be used (as described below with reference to FIG. 2, for example).

Furthermore, as an alternative to comprising a pillow-like structure, the insulating body portion 11 can be made of an insulating material and may be more rigid than a pillow-like structure. For example, the insulating body portion 11 could be made of a block of foam, such as a polyisocyanurate foam, polystyrene (including expanded polystyrene), mineral wool, wood, or polyurethane.

The size of the insulation device 10 will depend on the type of loft opening in which it is intended to be arranged; in particular, it will be appreciated that the width and length of the insulation device 10 will vary to take different loft openings into account. The thickness of the insulation device will also vary depending on insulation and/or fire safety requirements. For example, an insulation device 10 with a thickness in the range of 10 cm to 350 cm should suffice for most applications. It will be appreciated that, due to a large variation in the dimensions of loft openings, the size of the insulation device 10 will not always correspond exactly to a loft opening in which it is intended to be used. However, the skirt portion 12 of the insulation device 10 will serve to cover any gaps that arise due to a less than ideal fit of the insulation device 10 in the loft opening.

The insulation device 10 can be supplied as a complete article that simply needs to be inserted in a loft opening 13, and if desired, attached to a closure 15 for the loft opening 13. Alternatively, the insulation device 10 can be supplied as a kit of parts in which the insulating body portion 11 and the skirt portion 12 are provided separately and need to be attached to one another for use, for example by fasteners, such as buttons. In the case of a pillow-like structure, the casing 18 and filling for the pillow-like structure may be supplied separately so that a user can select how much filling to insert into the casing 18; the casing 18 could have an opening through which the filling could be inserted and, that opening could be closable, either temporarily or permanently, by the user. The casing 18, which as mentioned above can be fire and/or flame retardant, could be provided alone for a user to fill with their own selected filling. For example, the casing 18 could be in the form of a fire and/or flame retardant bag.

It will be understood that the terms “fill”, “filled” and “filling” include partial filling of the insulating body portion 10; a certain degree of compressibility of the insulating body portion 10 is required for effective insulation and draught exclusion.

Referring now to FIG. 2, in an alternative embodiment of the present invention, there is provided an insulation device 20 in which the pillow-like structure of the insulating body portion 21 does not have a box configuration. The skirt portion 22 of the insulation device 20 has a pillow-like structure that is similar to the pillow-like structure of the insulating body portion 21, which improves the thermal insulation properties of the skirt portion 22.

FIG. 3 shows a plan view of the insulation device 20 and in particular, the stiffened seam 27 about which the skirt portion 22 can move relative to the insulating body portion 21.

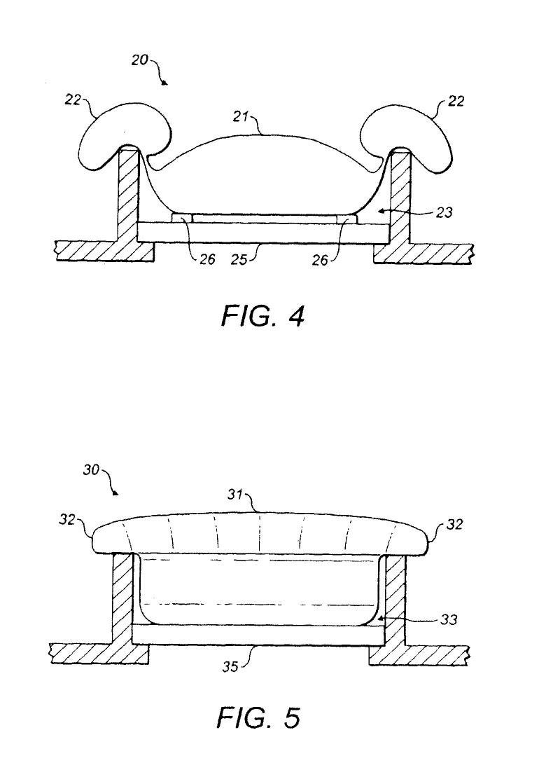

FIG. 4 shows a side view of the insulation device 20 arranged in a loft opening 23 and attached to a closure 25 by means of attachment means 26. It can be seen that when the loft opening 23 is closed by means of the closure 25, the skirt portion 22 of the insulation device 20 blocks off gaps around the periphery of the loft opening 23 that are not totally covered by the insulating body portion 21 of the insulation device 20.

FIG. 5 shows a side view of an insulation device 30 arranged in a loft opening 33 and attached to a closure 35. Although the insulation device 30 has a pillow-like structure, the skirt portion 32 of the insulation device 30 is not movable relative to the insulating body portion 31 of the insulation device 30. However, the skirt portion 32 still serves to block off gaps in the loft opening 33 that are not covered by the insulating body portion 31.

It will be appreciated that for all of the embodiments of insulation device 10, 20, 30 described above, the device 10, 20, 30 can be installed simply, by placing it on top of a respective closure 15, 25, 35 for the loft opening. If necessary, the insulation device 10, 20, 30 can be attached, either temporarily or permanently, to the closure 15, 25, 35. Following installation, the presence of the loft insulation device 10, 20, 30 should not impede the opening and closing of the closure 15, 25, 35.

The above embodiments are to be understood as illustrative examples of the invention. Further embodiments of the invention are envisaged. For example, it has been described above that the insulation device 10, 20, 30 is installed in combination with a closure 15, 25, 35 for a loft opening 13, 23, .31 However, it is not necessary for the loft opening 12, 23, 33 to have a closure 15, 25, 35; instead the insulation device 10, 20, 30 could be installed directly in a loft opening 13, 23, 33.

The insulation device 10, 20, 30 does not have to have a skirt portion. It will be appreciated that a fire and/or flame retardant bag could simply be filled with an insulating material and if the filled bag were sufficiently large and compressible, it could cover a loft opening and also any gaps around the periphery of the opening without impeding movement of the closure of the loft opening.

In cases where a skirt portion 12, 22, 32 is provided, it is not necessary for the skirt portion 12, 22, 32 to be joined to the insulating body portion 11, 21, 31 of the insulation device 10, 20, 30 by means of a stiffened seam.

A further alternative to the embodiments of the invention described above is an insulation device in the form of a bung with tapered sides. The bung could be inserted into a loft opening so that the tapered sides would seal the periphery of the loft opening. The bung could be made of rubber, foam or any other suitable material, or it could take the form of a bag with tapered sides filled with an insulating material.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An insulation device for a loft opening, the device comprising an insulating body portion adapted to fit within the loft opening and a skirt portion extending around at least a part of a periphery of the insulating body portion, wherein the skirt portion is adapted to be moveable relative to the insulating body portion.

2. The insulation device of claim 1, wherein the insulating body portion is made of an insulating material.

3. The insulation device of claim 1, wherein the insulating body portion has a pillow-like structure that is filled with an insulating material.

4. The insulation device of claim 1, wherein the skirt portion is made of an insulating material.

5. The insulation device of claim 1, wherein the skirt portion has a pillow-like structure that is filled with an insulating material.

6. The insulation device of claim 2, wherein the insulating material is selected from any of cellulose, cellulose acetate, fibreglass, paper, cardboard, carpet, wool, polyester, mineral wool, shredded bank notes, foam, cotton, recycled clothing, polystyrene or any combination thereof.

7. The insulation device of claim 1, wherein the skirt portion extends around the entire periphery of the insulating body portion.

8. The insulation device of claim 1, wherein the insulating body portion and the skirt portion are joined to one another by means of a stiffened seam.

9. The insulation device of claim 1, further including a fire retardant additive.

10. The insulation device of claim 1, further comprising a fire retardant liner.

11. The insulation device of claim 10, wherein the liner includes at least one perforation.

12. The insulation device of claim 10, wherein the liner is made of metal foil,

13. The insulation device of claim 10, wherein the liner has a thickness in the range of 10 micrometres to 5 millimetres.

14. The insulation device of claim 1, further including a flame retardant additive.

15. The insulation device of claim 1, further comprising means for attaching the device to a closure for a loft opening.

16. An insulation device for a loft opening, the device comprising an insulating body having a first portion adapted to fit within a loft opening and a second portion adapted to overlap a periphery of the loft opening, wherein the insulating body has a pillow-like structure.

17. A fire retardant bag for insulating a loft opening, wherein the bag is arranged to be filled with an insulating material so that it can assume a pillowlike structure, in use.

18. A fire retardant bag as claimed in claim 17, further comprising means for attaching the bag to a closure for a loft opening.

19. A fire retardant bag as claimed in claim 17, further comprising an opening through which the insulating material can be introduced into the bag.
